(19) United States
(12) Patent Application Publication
(10) Pub. No.: US 2005/0238832 A1
(43) Pub. Date: Oct. 27, 2005

(54) Hose with variable reinforcement

(76) Inventor: Dale E. Kostamo, Gainesville, FL (US)

Correspondence Address: DAYCO PRODUCTS, LLC, 1 PRESTIGE PLACE, MIAMISBURG, OH, 45342, US

(21) Appl. No.: 10/830,606

(22) Filed: Apr. 22, 2004

(51) Int. Cl. B32B 1/08

(52) U.S. Cl. 428/36.91

(57) ABSTRACT

A flexible hose for transporting fluid and a method for the manufacture of such hose is described. The hose comprises a polymeric inner tubular structure having an inner surface through which a fluid is conveyed and an outer surface; an outer protective cover; and a reinforcement member disposed between the inner tubular structure and the outer protective cover, wherein the reinforcement member exhibits variable reinforcement characteristics in the hose length.

### BACKGROUND OF THE INVENTION

The present invention relates to hoses and particularly to high performance, reinforced hoses which are useful in a wide variety of applications. More specifically, the present invention relates to reinforced hoses wherein the reinforcement is varied in a controlled and predetermined manner throughout the length of the hose.

Rubber hoses are used in a variety of applications for transporting fluids such as liquids and gases. For example, such hoses are commonly used as garden hoses, refrigeration hoses, torque converter hoses, automotive heater hoses, coolant hoses, power transmission hoses, power steering hoses, etc. It is necessary that such hoses not only be flexible enough to meet dimensional configurations required for such applications, but that the hose be sufficiently resistant to internal forces which may tend to deform the hose due to high pressure of the liquid or gas flowing through the hose. In order to insure that the hose meets these requirements, manufacturers of hoses for use in such high temperature and high or low pressure environments typically include a reinforcement layer between an inner tubular layer and an outer tubular layer of an elastomeric or thermoplastic material.

Hoses employing textile and wire reinforcement are known and liberally described in the prior art. For example, U.S. Pat. Nos. 3,972,757; 4,758,455; 5,360,037; 5,398,729; 5,476,121; 5,488,975 and 6,074,717, among others, teach the desirability of providing textile fibers and metal wire as reinforcement in hoses used in high pressure applications to prevent rupture of such hoses. Typically, the reinforcements are spiral, braided, knit or woven materials. While the reinforcement hoses of the prior art may be capable of providing the rupture resistance desired, such reinforcement is applied to the hose in a simple, non varying configuration which cannot provide variable reinforcement features in several portions throughout a single hose. For example, hose performance may be improved by varying the reinforcement in a controlled and predetermined manner at each end of the hose to be more compatible with corresponding non similar mating connections. Therefore, with the coming of more sophisticated applications for reinforced hoses, it would be highly desirable to be able to vary the reinforcement at specified portions within a single hose.

### SUMMARY OF THE INVENTION

According to the present invention a flexible hose with controlled variable reinforcement and a method for manufacturing such hose are provided. The hose of the invention includes an inner tubular structure having an inner surface for transporting fluids, and an outer surface for supporting other layers; a protective outer tubular cover; and a reinforcement member disposed between the inner tubular structure and the protective outer tubular cover. The reinforcement member of the flexible hose includes a variable orientation of the reinforcement materials such that the reinforcement member exhibits variable characteristics at predetermined portions of the hose. More specifically, the hose of the invention includes a reinforcement member wherein a first portion of the reinforcement member includes a first dimensional orientation of the reinforcement material and one or more other portions of the reinforcement member include a different dimensional orientation of the reinforcement material. The variable dimensional orientation of the reinforcement material allows the reinforcement member to exhibit different reinforcement characteristics at different portions of the reinforcement member. In the present invention, the terms “first reinforcement characteristic,”“first dimensional orientation, second reinforcement characteristic” and “second dimensional orientation” simply mean that the reinforcement characteristic and/or dimensional orientation varies in one or more portions of the hose and the variances are controlled and predetermined.

Hose performance is dependent upon the orientation of the reinforcement employed in the hose. Therefore, the optimal reinforcement at one end of the hose may not be optimal at the other end or at another portion of the hose, particularly when mating connections differ on each end of the hose. For example, certain hoses have different inside diameters at either end. To optimize the performance at each end, it is desirable to apply varying reinforcement patterns, i.e., pitch, angle, etc. on the uncured, reinforced carcass to yield a particularly desired reinforcement pattern on each end of the hose which may require different patterns. Furthermore, the reinforcement at either end of the hose may not be optimal for the middle section or other intermediate sections of the hose due to the physical orientation or bending of the hose. In accordance with the invention, hose performance is improved by varying the dimensional orientation of the reinforcement material in a controlled manner throughout the hose length.

Accordingly, it is an object of the invention to provide a hose having variable reinforcement in predetermined portions of the hose. Such hose not only meets the rupture resistance typically required of a high performance hose, but also provides optimal performance with respect to other desired features required in specific applications.

It is another object of the invention to provide a method for manufacturing a hose having variable reinforcement which provides optimal performance with respect to certain desirable features of the hose in specific applications.

### BRIEF DESCRIPTION OF THE DRAWINGS

FIG. 1 is a sectional view of a hose of the invention with the protective cover stripped away to show one aspect of the invention;

FIG. 2 is a sectional view of a hose of the invention with the protective cover stripped away to show a different aspect of the invention; and

FIG. 3 is a sectional view of another hose of the invention with the protective cover stripped away to show still another aspect of the invention.

### DETAILED DESCRIPTION OF THE INVENTION

In accordance with the invention, a flexible hose having an inner surface and an outer surface, an outer protective cover, and a reinforcement member wherein the reinforcement exhibits variable reinforcement characteristic; and a method of manufacturing such flexible hose wherein the method comprises the steps of forming a polymeric tubular structure having an inner surface and an outer surface, forming a reinforcement member on the outer surface of the polymeric tubular structure wherein the reinforcement member is formed to provide at least one portion of the reinforcement member exhibiting a first reinforcement characteristic and at least one other portion of the reinforcement member exhibiting a second reinforcement characteristic, such that the first reinforcement characteristic is different from the second reinforcement characteristic; and forming a protective cover on the reinforcement member, are provided.

The orientation of the reinforcement member of the hose is varied in a controlled manner to provide improved performance of the hose in numerous applications where improved performance has not previously been achieved. Accordingly, it would be desirable for one end of a hose to have a certain reinforcement characteristic while other portions of the hose such as the opposite end or an intermediate portion of the hose to have a different reinforcement characteristic(s). For example, in a portion of the hose where sharp bends are required, the pitch of the reinforcement material may be altered in a controlled manner to provide a predetermined configuration which is different from the pitch in other portions of the hose where sharp bends are not required. The variable reinforcement of the hose is attained by controlling the dimensional orientation of the reinforcement as it is applied to the outer surface of the inner tubular structure, i.e., the pitch of the strands or braids of wire or fiber which make up the reinforcement material is controlled by varying the pitch of the reinforcement strands or braids to form a desirable predetermined pattern around the inner tubular structure in forming the reinforced hose.

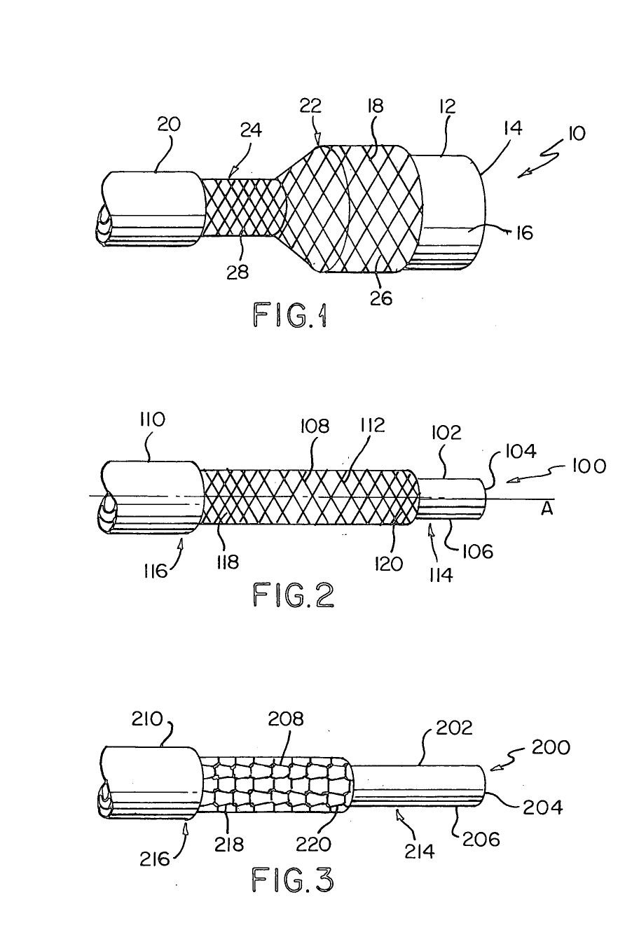

FIGS. 1 and 2 illustrate a first embodiment of the invention wherein a hose 10 having variable reinforcement. One aspect of the first embodiment is shown in FIG. 1 wherein the hose 10 includes a flexible inner tubular structure 12 having an inner surface 14 for conveying fluids and an outer surface 16, a protective outer cover 20, and a reinforcement member 18 sandwiched between the inner tubular structure 12 and the outer cover 20. The reinforcement member 18 is applied to the outer surface 16 of the inner tubular structure 12 and the protective outer cover 20 is applied over the reinforcement member such that the reinforcement member 18 is disposed between the inner tubular structure 12 and the outer protective cover 20. As illustrated in FIG. 1, the hose 10 includes a first portion 22 which is larger than a second portion 24 of the hose 10 and, in accordance with the invention, the spiral wound or braided reinforcement member 18 which surrounds the first portion 22 of the hose 10 exhibits an expanded reinforcement portion 26 with respect to the pattern, e.g., pitch, angle, density. etc. of the expanded reinforcement portion 26 of the reinforcement member 18 surrounding the first portion 22 of the hose 10, while the spiral wound or braided reinforcement member 18 surrounding the second portion 24 of the hose 10 exhibits a reduced reinforcement portion 28 of the reinforcement member 18 covering the second portion 24 of the hose with respect to the variable pattern of the reduced reinforcement portion 28.

FIG. 2 illustrates another aspect of the first embodiment, wherein the hose 100 includes a flexible inner tubular structure 102 having an inner surface 104 for conveying fluids, and an outer surface 106, a protective outer cover 110, and a reinforcement member 108 sandwiched between the inner tubular structure 102 and the outer cover 110. The reinforcement member 108 is applied to the outer surface 106 of the inner tubular structure 102 and the protective outer cover 110 is applied over the reinforcement member 108 such that the reinforcement member 108 is disposed between the inner tubular structure 102 and the outer protective cover 110. As illustrated in FIG. 2, the hose 100 has a uniform diameter along its axial length A. In accordance with this aspect of the invention, the spiral wound or braided reinforcement member 108 of the hose 100 exhibits an expanded reinforcement portion 112 intermediate the first and second reduced pitch portions 118 and 120, respectively. The expanded portion 112 exhibits expanded pattern when compared to the pattern of the portions 118 and 120 of the reinforcement member.

FIG. 3 illustrates another embodiment of the invention wherein the hose 200 includes a reinforcement member 208 of a woven or knit construction comprising natural or synthetic fibers or metal wire. The hose 200 includes a flexible inner tubular structure 202 having an inner surface 204 through which a fluid is conveyed, and an outer surface 206; an outer cover 210; and a reinforcement member 208 sandwiched between the inner tubular structure 202 and the outer cover 210. In this embodiment of the invention, the reinforcement member 208 exhibits a knit pattern rather than the spiral wound or braided pattern of the first embodiment of the invention. The knit pattern is designed to provide a reduced loop portion 218 in one end of the reinforcement member 208 and an expanded loop portion 220 at the opposite end of the reinforcement member 208. In another aspect of this embodiment, the reinforcement member 208 may be designed to provide one or more expanded portions and/or one or more reduced portions at any location along the reinforcement member 208 to provide the desired configuration.

The variable reinforcement member of the present invention provides structural integrity to the hose and increases its pressure and puncture resistance as well as affording other desirable advantages which were heretofore unknown in the manufacture of reinforced hoses.

The flexible inner tubular structure of the hose of the present invention may comprise one or more separate layers, each of which is typically constructed from any of the conventional rubber or thermoplastic materials used in hose manufacture and which are able to withstand high temperatures and pressures and which are sufficiently resistant to the environmental conditions to which they are exposed, while also being flexible enough to be bent through sharp turns. By way of example, such materials include natural rubber; styrene-butadiene rubber (SBR); polychloroprene; ethylene-propylene diene terpolymer (EPDM); ethylene-propylene rubber (EPR); butyl rubber; nitrile rubber, hydrogenated nitrile-butadiene rubber; polybutadiene; polyisoprene; polyurethane; chlorinated polyethylene (CPE); chlorosulfonated polyethylene (CSM); Polyamides such as nylon 6, nylon 6-6, nylon 11, nylon 12; polyesters such as polyethylene terephthalate; acrylic acid ester rubber (ACM); ethylene-acrylic polymers (EA); ethylene-vinyl acetate copolymers, e.g., Levaprene, a high vinyl acetate containing copolymer manufactured by Bayer, and the like; and blends thereof

The outer cover layer of the hose is a protective cover which may be extruded or otherwise applied over the reinforcement member. The outer cover protects the interior members of the hose from abrasion and from other adverse effects caused be chemicals, oil, solvents, abrasive materials, etc. To which the hose may be exposed. Typically, the outer cover is in the form of a thin walled tube and may be constructed of conventional cover materials such as chlorinated polyethylene (CPE), chlorosulfonated polyethylene (CSM), nitrile rubber, hydrogenated nitrile-butadiene rubber, nitrile-polyvinyl chloride, ethylene-propylene-diene terpolymer (EPDM), polychloroprene, chlorobutyl rubber, nylon, acrylic acid ester rubber (ACM); ethylene-acrylic polymers (EA); and the like. The particular material employed should be chosen according to the environmental and operating conditions the hose is expected to encounter.

The materials employed for constructing the reinforcement member of the invention include metal wire, natural fibers, synthetic fibers and the like, or a combination thereof Preferably, the reinforcement member is constructed from natural or synthetic fibers such as cotton fiber, glass fiber, carbon fiber, boron fiber, silicon carbide fiber, rayon fiber, nylon fiber, aramid fiber, polypropylene fiber, polyester fiber and combinations thereof In an optional embodiment of the invention for certain applications, it may be desirable to pre treat the reinforcement with a suitable material, e.g., resorcinolformaldehyde latex (RFL) or other suitable adhesion enhancing materials to enhance the adhesion between the reinforcement member and the adjacent tubular structures.

Certain additives which are used in the conventional manufacture of rubber hoses may be employed in forming either or both of the flexible inner tubular layers and the outer cover, depending on the particular purpose and application intended for the hose. Useful additives include fillers such as carbon black (which also may be employed as a conductive material, particularly at the inner surface of the inner tubular structure when a conductive inner surface is desired such as in the transport of flammable fluids) silica, calcium carbonate, calcium sulfate, clay, diatomaceous earth, mica and the like; softeners such as mineral oils, vegetable oils, synthetic plasticizers; crosslinking agents such as organic peroxides, sulfur, etc; vulcanization promoter; antioxidants and the like.

In accordance with the present invention there is also provided a method for manufacturing a flexible hose having a variable reinforcement wherein the method comprises the steps of: forming a polymeric tubular structure having an inner surface and an outer surface; forming a reinforcement member on the outer surface of the polymeric tubular structure. wherein the reinforcement member is formed to provide at least one portion of the hose exhibiting a first reinforcement characteristic and at least one other portion of the hose exhibiting a second reinforcement characteristic, wherein the first reinforcement characteristic is different from the second reinforcement characteristic; and forming a protective cover on the reinforcement member. Preferably, a first continuous tubular structure of elastomeric or thermoplastic material is formed by extruding the material in an axial direction to form a flexible elastomeric or thermoplastic tubular structure which ultimately becomes the inner layer. of the present hose. A reinforcement member, in the form of braids which include multiple strands of natural or synthetic fibers or metal wire is then wound, spiraled, coiled, twisted or otherwise formed around the flexible inner tubular structure in a controlled manner such that the resulting reinforcement member exhibits desired, predetermined variable reinforcement characteristics at specified portions of the hose length. Typically, the reinforcement member includes one or more braids wherein each braid contains a plurality of wires or fibers. Preferably, each braid contains at least about 6 wires or fibers and up to about 36 wires or fibers, depending on the use of the reinforced hose. Most preferably each braid contains about 6 to 20 wires or fibers. According to the invention, the wires or fibers crisscross in a predetermined manner and at a predetermined pitch to provide a specific dimensional orientation which exhibits a desired reinforcement characteristic. The dimensional orientation of the reinforcement member is defined by the pitch at which the reinforcement materials are wound around the inner tubular structure or, in the case of knit reinforcement members, by the distance between the loops of the reinforcement material.

It may be desirable to enhance the adhesion between the reinforcement member and the inner tubular structure and/or the outer cover. The adhesion may be enhanced by pre treating the reinforcing strands with a suitable material having adhesion enhancing properties, or by coating a separate layer of an adhesion enhancing material in one or two separate steps between the inner tubular structure and the reinforcement member, and/or between the reinforcement member and the outer cover during extrusion of the hose. Conventional adhesion enhancing materials, e.g., a resorcinolfornaldehyde latex, and the like may be employed for this purpose.

The reinforcement materials are wound onto an inner tubular structure to provide a predetermined and controlled reinforcement pattern around the inner tubular structure such that the reinforcement exhibits a variable reinforcement at desirable and predetermined portions of the resulting hose. Typically, the reinforcement materials include a plurality of natural or synthetic fibers or metal wires wound and counter wound at a predetermined pitch with respect to the longitudinal axis of the tubular structure at a first portion of the hose, and then the reinforcement materials are wound and counter wound at a different predetermined pitch and/or angle or reinforcement density with respect to the longitudinal axis of the tubular structure at a different portion of the hose.

Alternately, the reinforcement materials are knitted or woven to form a mesh. The knitted or woven reinforcement members are continuously and variably placed around the inner tubular structure to provide a first predetermined loop spacing around a predetermined portion of the tubular structure, and a second predetermined loop spacing around a second predetermined portion of the tubular structure. The first and second loop spacings are different from each other so that the reinforcement members exhibit variable reinforcing characteristics to specified portions of the tubular structure.

The preferred method of manufacturing the hose comprises the steps of: forming an elastomeric or thermoplastic tubular structure having an inner surface and an outer surface; forming a reinforcement member on the outer surface of the first tubular structure by circumferentially winding a reinforcement material comprising a plurality of fibers or wires, preferably braided, around the outer surface of the elastomeric or thermoplastic tubular structure in a controlled manner in, e.g., a shuttle-type maypole braider that produces a two-over, two-under braid pattern; and finally forming a protective cover around the reinforcement member.

The step of forming the reinforcement member further includes monitoring and adjusting means, e.g., computerized robotics for continuously monitoring line speed, deck speed, etc. and adjusting the dimensional orientation of the reinforcing material during the formation of the reinforcement member to maintain a constant tension pattern, in accordance with predetermined specifications and pre specified instructions. Other means such as ultrasonic sensors, dimension measurement systems, vacuum pressure variation systems which calculate and maximize critical parameters for applying the reinforcement, also may be employed.

Proper vision systems may be employed to mark and/or cut the hose at specified lengths so that each individual hose is formed and recovered according to predetermined length and reinforcement variation specifications, thus enabling continuous manufacture of hoses having variable reinforcement. Under certain conditions, however, it may be desirable to build the hose lengths manually or semi-mechanically.

While certain preferred aspects and embodiments of the invention have been specifically illustrated and described herein, it will be understood that various other aspects and embodiments, and other modifications thereof may be practiced without deviating from the scope of the invention as defined by the appended claims.

1. A flexible hose for transporting fluid, said hose comprising:
a polymeric tubular structure having an inner surface through which fluids are transported, and an outer surface;
a reinforcement member disposed on the outer surface of said polymeric tubular structure, said reinforcement member exhibiting variable reinforcement characteristics; and
an outer protective cover around said reinforcement member.

2. The hose of claim 1, wherein said reinforcement member includes at least one portion thereof comprising a first dimensional orientation which exhibits a first reinforcement characteristic and at least one other portion thereof exhibiting a second dimensional orientation which exhibits a second reinforcement characteristic, wherein said first dimensional orientation is different from said second dimensional orientation.

3. The hose of claim 2 wherein said first dimensional orientation is a first angular orientation and said second dimensional orientation is a second angular orientation.

4. The hose of claim 2 wherein said first dimensional orientation is a first reinforcement pitch and said second dimensional orientation is a second reinforcement pitch.

5. The hose of claim 1 wherein said reinforcement member comprises one of metal wire, natural fiber and synthetic fiber.

6. The hose of claim 5 wherein said reinforcement member comprises natural fiber or synthetic fiber selected from the group consisting of cotton fiber, glass fiber, carbon fiber, boron fiber, silicon carbide fiber, rayon fiber, nylon fiber, aramid fiber, polypropylene fiber, polyester fiber and combinations thereof.

7. The hose of claim 1 wherein said reinforcement member is one of a spiral, braid, knit and woven construction.

8. The hose of claim 5 wherein said reinforcement member is steel wire.

9. The hose of claim 1 wherein said polymeric tubular structure is selected from the group consisting of natural rubber; styrene-butadiene rubber (SBR); nitrile rubber, hydrogenated nitrile-butadiene rubber, polychloroprene; ethylene-propylene diene terpolymer (EPDM); ethylene-propylene rubber (EPR); butyl rubber; polybutadiene; polyisoprene; polyurethane; chlorinated polyethylene (CPE); chlorosulfonated polyethylene (CSM); Polyamides; polyesters; acrylic acid ester rubber (ACM); ethylene-acrylic polymers (EA); and blends thereof.

10. The hose of claim 1 wherein said outer protective cover is selected from selected from the group consisting of natural rubber; styrene-butadiene rubber (SBR); nitrile rubber; hydrogenated nitrile-butadiene rubber; polychloroprene; ethylene-propylene diene terpolymer (EPDM); ethylene-propylene rubber (EPR); butyl rubber; polybutadiene; polyisoprene; polyurethane; chlorinated polyethylene (CPE); chlorosulfonated polyethylene (CSM); Polyamides; polyesters; acrylic acid ester rubber (ACM); ethylene-acrylic polymers (EA); and blends thereof.

11. The hose of claim 1 further comprising an adhesion promoter disposed between said inner tubular structure and said reinforcement member, and/or between said reinforcement member and said outer cover.

12. The hose of claim 1 wherein said adhesion promoter is a resorcinolformaldehyde latex.

13. The hose of claim 1 wherein said reinforcement member is a pre treated reinforcement member having been pre treated with an adhesion promoter.

14. The hose of claim 13 wherein said adhesion promoter is a resorcinolformaldehyde latex.

15. A flexible elastomeric or thermoplastic hose for transporting fluid, said hose comprising:
a tubular structure having an inner surface and an outer surface, said inner tubular structure comprising an elastomeric or thermoplastic material selected from the group consisting of natural rubber; styrene-butadiene rubber (SBR); nitrile rubber; hydrogenated nitrile-butadiene rubber; polychloroprene; ethylene-propylene diene terpolymer (EPDM); ethylene-propylene rubber (EPR); butyl rubber; polybutadiene; polyisoprene; polyurethane; chlorinated polyethylene (CPE); chlorosulfonated polyethylene (CSM); Polyamides; polyesters; acrylic acid ester rubber (ACM); ethylene-acrylic polymers (EA); and blends thereof;
a variable reinforcement member comprising one of metal wire, natural fiber and synthetic fiber on the outer surface of said tubular structure, wherein said variable reinforcement member includes a first portion thereof comprising a first dimensional orientation exhibiting a first reinforcement characteristic, and at least one other portion thereof comprising a second dimensional orientation exhibiting a second reinforcement characteristic, wherein said first reinforcement characteristic is different from said second reinforcement characteristic; and
an outer protective cover selected from the group consisting of natural rubber; styrene-butadiene rubber (SBR); nitrile rubber; hydrogenated nitrile-butadiene rubber; polychloroprene; ethylene-propylene diene terpolymer (EPDM); ethylene-propylene rubber (EPR); butyl rubber; polybutadiene; polyisoprene; polyurethane; chlorinated polyethylene (CPE); chlorosulfonated polyethylene (CSM); Polyamides; polyesters; acrylic acid ester rubber (ACM); ethylene-acrylic polymers (EA); and blends thereof.

16. The hose of claim 15 wherein said first dimensional orientation is a first angular orientation and said second dimensional orientation is a second angular orientation.

17. The hose of claim 15 wherein said first dimensional orientation is a first reinforcement pitch and said second dimensional orientation is a second reinforcement pitch.

18. The hose of claim 15 further comprising an adhesion promoter disposed between said inner tubular structure and said reinforcement member, and/or between said reinforcement member and said outer cover.

19. The hose of claim 18 wherein said adhesion promoter is a resorcinolformaldehyde latex.

20. The hose of claim 15 wherein said reinforcement member is a pre treated reinforcement member having been pre treated with an adhesion promoter.

21. The hose of claim 20 wherein said adhesion promoter is a resorcinolformaldehyde latex.

22. A method of manufacturing a flexible elastomeric hose having variable reinforcement comprising the steps of:
forming a polymeric tubular structure having an inner surface and an outer surface;
forming a reinforcement member on the outer surface of said polymeric tubular structure whereby said reinforcement member is formed to provide at least one portion thereof having a first dimensional orientation which exhibits a first reinforcement characteristic, and at least one other portion thereof having a second dimensional orientation which exhibits a second reinforcement characteristic, wherein said first reinforcement characteristic is different from said second reinforcement characteristic; and
forming a protective cover on said reinforcement member.

23. The method of claim 22 wherein said first dimensional orientation is a first angular orientation and said second dimensional orientation is a second angular orientation.

24. The method of claim 22 wherein said first dimensional orientation is a first reinforcement pitch and said second dimensional orientation is a second reinforcement pitch.

25. The method of claim 22 further comprising the step of forming a layer of an adhesion promoter adjacent said reinforcement member.

26. The method of claim 25 wherein said adhesion promoter is a resorcinolformaldehyde latex.

27. The method of claim 25 wherein said adhesion promoter is formed between said inner tubular structure and said reinforcement member.

28. The method of claim 25 wherein said adhesion promoter is formed between said reinforcement member and said outer cover.

29. The method of claim 25 wherein a first layer of adhesion promoter is formed between said inner tubular structure and said reinforcement member, and a second layer of adhesion promoter is formed between said reinforcement member and said outer cover.

30. The method of claim 22 wherein said reinforcement member is a pre treated reinforcement member having been pre treated with an adhesion promoter.

31. The method of claim 22 wherein said reinforcement member comprises one of metal wire, natural fiber and synthetic fiber.

32. The method of claim 31 wherein said reinforcement member comprises natural fiber or synthetic fiber selected from the group consisting of cotton fiber, glass fiber, carbon fiber, boron fiber, silicon carbide fiber, rayon fiber, nylon fiber, aramid fiber, polypropylene fiber, polyester fiber and combinations thereof.

33. The method of claim 31 wherein said reinforcement member is one of a spiral, braid, knit and woven construction.

34. The method of claim 31 wherein said reinforcement member is steel wire.

35. The method of claim 22 wherein said polymeric tubular structure is selected from the group consisting of natural rubber; styrene-butadiene rubber (SBR); nitrile rubber; hydrogenated nitrile-butadiene rubber; polychloroprene; ethylene-propylene diene terpolymer (EPDM); ethylene-propylene rubber (EPR); butyl rubber; polybutadiene; polyisoprene; polyurethane; chlorinated polyethylene (CPE); chlorosulfonated polyethylene (CSM); Polyamides; polyesters; acrylic acid ester rubber (ACM); ethylene-acrylic polymers (EA); and blends thereof

36. The method of claim 22 wherein said outer protective cover is selected from selected from the group consisting of natural rubber; styrene-butadiene rubber (SBR); nitrile rubber; hydrogenated nitrile-butadiene rubber; polychloroprene; ethylene-propylene diene terpolymer (EPDM); ethylene-propylene rubber (EPR); butyl rubber; polybutadiene; polyisoprene; polyurethane; chlorinated polyethylene (CPE); chlorosulfonated polyethylene (CSM); Polyamides; polyesters; acrylic acid ester rubber (ACM); ethylene-acrylic polymers (EA); and blends thereof.

37. The method of claim 22 wherein said method further comprises continuously monitoring the formation of said reinforcement member and continuously adjusting the orientation thereof as said reinforcement member is formed on the outer surface of said inner tubular structure.

38. The method of claim 22 wherein said method further comprises marking and/or cutting said hose at a predetermined hose length.
